(19) United States
(12) Patent Application Publication
(10) Pub. No.: US 2012/0302263 A1
(43) Pub. Date: Nov. 29, 2012

(54) ESTIMATING ACCESS TERMINAL LOCATION BASED ON UPLINK SIGNALS

(75) Inventors: Peerapol TINNAKORNSRISUPHAP, San Diego, CA (US); Varun Khaitan, San Diego, CA (US); Mehmet Yavuz, San Diego, CA (US)

(73) Assignee: QUALCOMM Incorporated, San Diego, CA (US)

(21) Appl. No.: 13/305,678

(22) Filed: Nov. 28, 2011

Related U.S. Application Data
(60) Provisional application No. 61/417,766, filed on Nov. 29, 2010.
(60) Provisional application No. 61/472,528, filed on Apr. 6, 2011.

(51) Int. Cl. H04W 52/24; H04W 24/00

(52) U.S. Cl. 455/456.6

(57) ABSTRACT

A location of an access terminal is estimated based on uplink signals that a plurality of femto cells receive from the access terminal. The transmit power of the access terminal may be adjusted in some cases to facilitate the reception of signals at the femto cells during a location determination operation. In some embodiments, a location of an access terminal is estimated based on relative path loss values derived from the signals received by the femto cells.

### CLAIM OF PRIORITY

This application claims the benefit of and priority to commonly owned U.S. Provisional Patent Application No. 61/417,766, filed Nov. 29, 2010, and assigned Attorney Docket No. 110372P1, and U.S. Provisional Patent Application No. 61/472,528, filed Apr. 6, 2011, and assigned Attorney Docket No. 110372P2, the disclosure of each of which is hereby incorporated by reference herein.

### BACKGROUND

1. Field

This application relates generally to wireless communication and more specifically, but not exclusively, to determining a location of an access terminal.

2. Introduction

A wireless communication network may be deployed over a defined geographical area to provide various types of services (e.g., voice, data, multimedia services, etc.) to users within that geographical area. In a typical implementation, access points (e.g., each supporting one or more macro cells) are distributed throughout a macro network to provide wireless connectivity for access terminals (e.g., cell phones) that are operating within the geographical area served by the network.

Access terminal-related applications may make use of the location of the access terminal. For example, the location of an access terminal may be reported during a 911 call by the access terminal. As another example, an access terminal-based navigation system uses the current location of the access terminal for providing navigational aids.

Various techniques have been used to estimate the location of an access terminal. In some implementations, an access terminal is configured to calculate location based on signals received from nearby macro cells. In some implementations, an access terminal includes a Global Positioning System (GPS) receiver that receives signals from GPS satellites to determine the current location of the access terminal. In some implementations, an access terminal includes a Wi-Fi transceiver that calculates location based on signals received from nearby Wi-Fi base stations.

These techniques may estimate a location based on analysis of received signal strength or received signal timing. Several examples these schemes follow. Signal Strength Triangulation and Fingerprinting is a method where the location of an access terminal is estimated by obtaining a set of signal strength measurements from a group of transmitters and matching this set, known as a fingerprint, against a database of measurements from a grid of points in the coverage area. Advanced Forward Link Trilateration (AFLT) is a location technology that relies on a time difference of arrival from multiple base stations at the access terminal. Observed Time Difference Of Arrival (OTDOA) is a standardized location estimation method for UMTS where the observed time difference of pilots between a pair of base station signals at the access terminal is used to calculate an estimate of the location (as a hyperboloid) and optionally, the velocity of the access terminal. Uplink Time Difference of Arrival (UTDOA) is also a standardized location estimation method for UMTS where the observed time difference is calculated between the access terminal and a pair of Location Measurement Units (LMUs). The observed time difference is calculated by maximizing the correlation of time-shifted received signals at the LMUs.

In practice, conventional location estimation technologies such as GPS and macro cell tower based location estimation may not be very effective indoors due to poor signal quality or limited accuracy in location estimation. For example, satellite-based location estimation systems such as GPS may perform poorly indoors as the signals from the satellites may be too weak to be decoded. Traditional terrestrial-based location estimation techniques used in macro cellular environments also may not yield satisfactory accuracy required for indoor applications.

Moreover, some conventional location technologies require that the access terminal include specialized hardware. For example, a GPS-based scheme requires that the access terminal include a GPS receiver. Similarly, a Wi-Fi-based scheme requires that the access terminal include a Wi-Fi transceiver. Consequently, these techniques cannot be used on legacy access terminals that do not include the necessary hardware.

In view of the above, there is a need for improved techniques for estimating the location of an access terminal (e.g., in an indoor environment).

### SUMMARY

A summary of several sample aspects of the disclosure follows. This summary is provided for the convenience of the reader and does not wholly define the breadth of the disclosure. For convenience, the term some aspects may be used herein to refer to a single aspect or multiple aspects of the disclosure.

The disclosure relates in some aspects to estimating a location of an access terminal (and, hence, the position of a user of the access terminal) based on uplink signals measured by a group of femto cells. In some aspects, the location of an access terminal may be determined using one of the techniques that follow or a combination of these techniques. A group of femto cells may measure the received strength of signals received from the access terminal (e.g., a reverse link pilot signal). A group of femto cells may measure the timing associated with signals received from the access terminal (e.g., time differences of arrival (TDOA) or round trip time (RTT)).

In these methods, a so-called “fingerprint” based on the current set of measured information (e.g., relative pathloss differences for the access terminal or relative signal transmission delays measured at each femto cell) may be obtained and matched against different sets of previously defined fingerprints associated with different locations within a given environment (e.g., within the coverage of a set of femto cells). By comparing the current fingerprint with the previously defined fingerprint information, a location that is most likely associated with the current fingerprint may be identified. This location is then indicated as corresponding to the current location of the access terminal. For example, in implementations where values indicative of relative path loss are derived from signal strength (e.g., Ecp) and interference (e.g., Nt) information, a given fingerprint (corresponding to a given location) may include several relative path loss values, where each value is associated with a unique femto cell pair (e.g., location M corresponds to relative path loss values X, Y, and Z associated with femto cell pairs A-B, A-C, and A-D, respectively). In implementations that use transmission delay information, a given fingerprint (corresponding to a given location) may include several time delay values, where each value is associated with different one of femto cells (e.g., location M corresponds to signal propagation time delays X, Y, and Z from an access terminal to femto cells A, B, and C, respectively).

In some implementations, the defined fingerprint information is implemented as a database or prediction model. Values for the database or prediction model may be generated, for example, by ray tracing models that use knowledge of the physical environment around the femto cells and the building materials. Here, for each designated location within the physical environment, a set of values of received signal strengths (or corresponding relative path losses) or propagation times from all femto cells “seen” at that location is created. Thus, each defined location within the environment is associated with a set of values (e.g., relative path loss or timing values) corresponding to the values (or a range of values) that are expected at that location. These values are then stored in the database in association with the corresponding defined location.

In conjunction with the above operations and other operations as taught herein, one or more components of a communication system may be configured to support various communication schemes. In some aspects, a communication scheme implemented in accordance with the teachings herein involves: receiving, from a plurality of femto cells, signal strength information corresponding to signals measured by the femto cells from an access terminal; determining relative path loss values associated with the femto cells based on the received signal strength information; and estimating a location of the access terminal based on the relative path loss values. As another example, in some aspects, a communication scheme implemented in accordance with the teachings herein involves: receiving, from a plurality of femto cells, signal propagation delay values corresponding to signals received by the femto cells from an access terminal; comparing the received signal propagation delay values to sets of defined delay values that are associated with different locations; and estimating a location of the access terminal based on the comparison.

In some embodiments, the transmit power of the access terminal may be adjusted (e.g., increased) to ensure that a sufficient number of femto cells are able to receive uplink signals from the access terminal during a location determination operation. For example, upon commencing signal measurement operations, a determination may be made as to the number of femto cells that are able to receive signals (e.g., pilot signals) from the access terminal. If the number of femto cells is insufficient to enable the calculation of a reliable location estimate, a power control parameter (e.g., a set point) for the access terminal may be adjusted so that the access terminal will increase its transmit power. Thus, in some aspects, a communication scheme implemented in accordance with the teachings herein involves: determining that at least one location of an access terminal is to be estimated; and sending a signal to adjust transmit power of the access terminal as a result of the determination.

### BRIEF DESCRIPTION OF THE DRAWINGS

These and other sample aspects of the disclosure will be described in the detailed description and the claims that follow, and in the accompanying drawings, wherein:

FIG. 1 is a simplified block diagram of several sample aspects of a communication system adapted to estimate a location of an access terminal;

FIG. 2 is a flowchart of several sample aspects of operations that may be performed in conjunction with estimating a location of an access terminal based on relative path loss values;

FIG. 3 is a flowchart of several sample aspects of operations that may be performed in conjunction with estimating a location of an access terminal based on timing of uplink signals measured by a plurality of femto cells;

FIG. 4 is a flowchart of several sample aspects of operations that may be performed in conjunction with adjusting access terminal transmit power for access terminal location estimation;

FIG. 5 is a simplified block diagram of several sample aspects of components that may be employed in communication nodes;

FIG. 6 is a simplified diagram of a wireless communication system;

FIG. 7 is a simplified diagram of a wireless communication system including femto nodes;

FIG. 8 is a simplified diagram illustrating coverage areas for wireless communication;

FIG. 9 is a simplified block diagram of several sample aspects of communication components; and

FIGS. 10-12 are simplified block diagrams of several sample aspects of apparatuses configured to support access terminal location estimation as taught herein.

In accordance with common practice the various features illustrated in the drawings may not be drawn to scale. Accordingly, the dimensions of the various features may be arbitrarily expanded or reduced for clarity. In addition, some of the drawings may be simplified for clarity. Thus, the drawings may not depict all of the components of a given apparatus (e.g., device) or method. Finally, like reference numerals may be used to denote like features throughout the specification and figures.

### DETAILED DESCRIPTION

Various aspects of the disclosure are described below. It should be apparent that the teachings herein may be embodied in a wide variety of forms and that any specific structure, function, or both being disclosed herein is merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. Furthermore, an aspect may comprise at least one element of a claim.

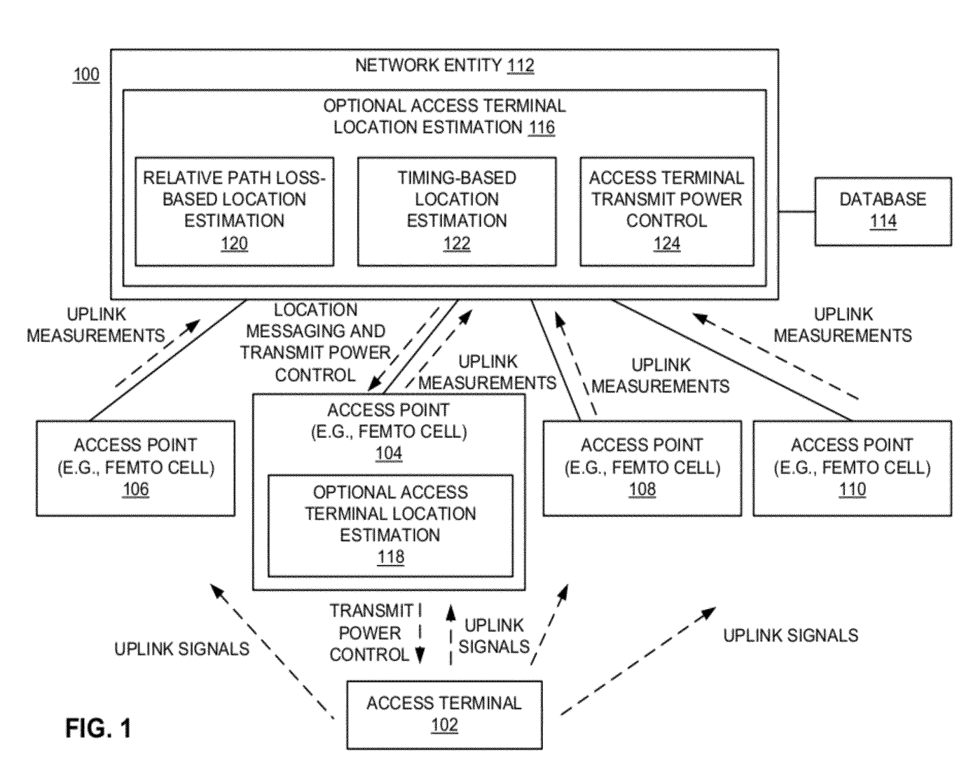

FIG. 1 illustrates several nodes of a sample communication system 100 (e.g., a portion of a communication network). For illustration purposes, various aspects of the disclosure will be described in the context of one or more access terminals, access points, and network entities that communicate with one another. It should be appreciated, however, that the teachings herein may be applicable to other types of apparatuses or other similar apparatuses that are referenced using other terminology. For example, in various implementations access points may be referred to or implemented as base stations, NodeBs, eNodeBs, femto cells, Home NodeBs, Home eNodeBs, and so on, while access terminals may be referred to or implemented as user equipment (UEs), mobile stations, mobile devices, and so on.

Access points in the system 100 provide access to one or more services (e.g., network connectivity) for one or more wireless terminals (e.g., an access terminal 102) that may be installed within or that may roam throughout a coverage area of the system 100. For example, at various points in time the access terminal 102 may connect to an access point 104, an access point 106, an access point 108, an access point 110, or some access point in the system 100 (not shown). Each of these access points may communicate with one or more network entities (represented, for convenience, by a network entity 112) to facilitate wide area network connectivity.

The network entity 112 may take various forms such as, for example, one or more radio and/or core network entities. Thus, in various implementations the network entity 112 may represent functionality such as at least one of: network management (e.g., via an operation, administration, management, and provisioning entity), call control, session management, mobility management, gateway functions, interworking functions, or some other suitable network functionality. In some aspects, mobility management relates to: keeping track of the current location of access terminals through the use of tracking areas, location areas, routing areas, or some other suitable technique; controlling paging for access terminals; and providing access control for access terminals. Also, two or more network entities may be co-located and/or two or more network entities may be distributed throughout a network.

In a typical implementation, the access points 104-110 comprise low-power access points (e.g., having a transmit power of 25 milliwatts or less). These low-power access points are typically deployed to supplement conventional network access points (e.g., macro access points) by providing more robust indoor wireless coverage or other coverage to access terminals. Such low-power access points may be referred to as, for example, femto access points, femto cells, home NodeBs, home eNodeBs, or access point base stations. Typically, such low-power access points are connected to the Internet and the mobile operator's network via a DSL router or a cable modem. For convenience, low-power access points may be referred to as femto cells or femto access points in the discussion that follows.

A femto cell may be deployed in the same frequency channel with the macro cell (co-channel deployment) or in a separate channel that is not in use by the macro cell (dedicated channel deployment). When an access terminal comes in close proximity of a femto cell, it detects the femto cell pilot and makes a handoff from the macro cell. An access terminal that is operating on the same channel with the femto cell detects the pilot through a neighbor list pilot search. For access terminals on the macro-only channels, handoff is enabled through transmission of beacon signals (e.g., pilot beacons). Alternatively, the access terminal may autonomously perform inter-frequency scans due to weak macro cell pilot or proximity to the femto cell.

The disclosure relates in some aspects to using a network of femto cells (e.g., a group or cluster of femto cells that are controlled by a common entity) for access terminal location operations. Advantageously, as the coverage of each femto cell is relatively small, a finer resolution may be achieved via location techniques based on triangulation of information (e.g., path loss and timing) derived from uplink signals that the femto cells receive from the access terminal. Moreover, the use of femto cells can facilitate locating legacy 3G access terminals without modification and without requiring support from any additional radio technology (e.g., GPS or Wi-Fi).

To this end, one or more of the entities of FIG. 1 include access terminal location estimation functionality and have access to a database 114 that stores fingerprint-related information. The database 114 may be located locally (e.g., located in the network entity 112 or the access point 104) or at a remote location in the network. Also, in some cases, the database 114 may be distributed whereby copies of the database information are stored at different entities in the network (e.g., stored in the network entity 112 and in the access point 104).

For purposes of illustration, the network entity 112 and the access point 104 are depicted as optionally including functionality for access terminal location estimation 116 and 118, respectively. It should be appreciated that other entities (e.g., other access points and access terminals) may include such functionality. For example, a network entity, a femto cell, an access terminal, or some other entity may control location estimation operations. Thus, for location estimation, such an entity may control monitoring of uplink transmissions by the femto cells. Moreover, such an entity may acquire uplink measurement information and use this information to estimate a location of the access terminal.

In some implementations, different steps of the location estimation procedure may be performed by different entities. For example, an application on an access terminal may initiate a location estimation procedure. The serving access point or some other network entity may then control the operation of the access points and access terminal to acquire the uplink information. In addition, one of these entities or some other entity may use the acquired information and information obtained from a local or network fingerprint database to estimate the location of the access terminal. Several typical examples follow.

In some implementations, the network entity 112 (e.g., a femto management server, a femto convergence server, or some other suitable entity) manages location estimation procedures. In this case, the network entity 112 may send control signals to the access points 104-110 to control uplink monitoring and reporting for a location estimation procedure. In addition, the network entity 112 may send control signals to the access point 104 (e.g., the current serving femto cell for the access terminal 102) to request that an active call be established with the access terminal 102 for the location estimation procedure. Upon completing a measurement operation, each access point 104-110 sends the resulting measurement information to the network entity 112. The network entity 112 uses the measurement information to estimate a location of the access terminal 102.

In some implementations, the access point 104 (e.g., the current serving femto cell for the access terminal 102) manages location estimation procedures. In this case, the access point 104 may send control signals to the access points 106-110 to control uplink monitoring and reporting for a location estimation procedure. In some embodiments, the access point 104 sends control signals to the access points 106-110 via the network entity 112. In some embodiments, the access points (e.g., femto cells) send control signals directly to each other (e.g., via interfaces such as Iur-h (for HNB) or X2 (for HeNB)). The access point 104 also controls its own uplink monitoring and reporting for the location estimation procedure. In addition, the access point 104 may ensure that an active call is established with the access terminal 102 for the location estimation procedure. Upon completing a measurement operation, each access point 106-110 sends the resulting measurement information to the access point 104 via the network entity 112. The access point 104 uses the measurement information it measures and the measurement information it receives to estimate a location of the access terminal 102.

In accordance, with the teachings herein, the access terminal location estimation 116 is depicted as includes several components that facilitate effective estimation of the location of an access terminal based on uplink signals. For purposes of illustration, only the access terminal location estimation 116 is depicted as comprising these components. It should be appreciated that other entities in a communication system (e.g., the access terminal location estimation 118) may include such functionality.

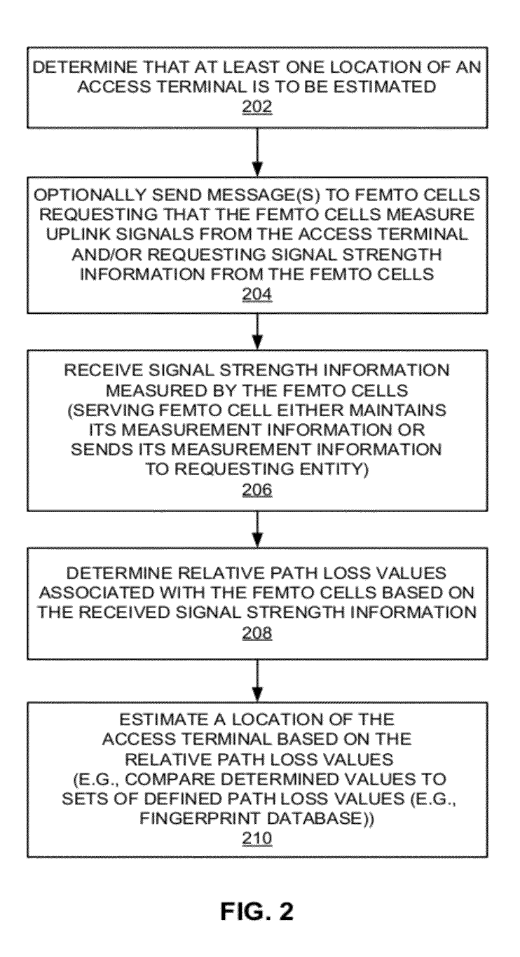

Relative path loss-based location estimation 120 involves deriving values indicative of relative path loss values associated with the femto cells from uplink signals measured by the femto cells, and using these values to estimate the access terminal location. Examples of these operations are described in more detail below in conjunction with FIG. 2.

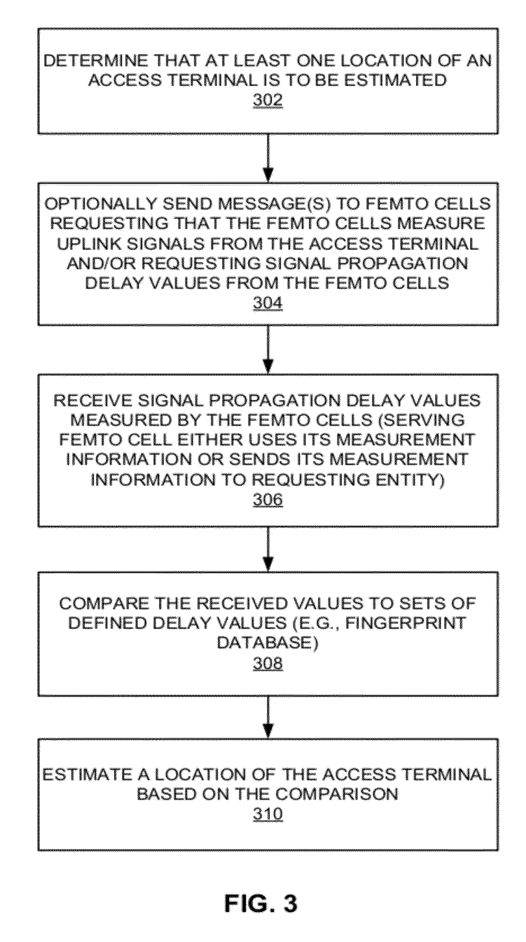

Timing-based location estimation 122 involves deriving signal propagation delay values from uplink signals measured by the femto cells and using these values to estimate the access terminal location. Examples of these operations are described in more detail below in conjunction with FIG. 3.

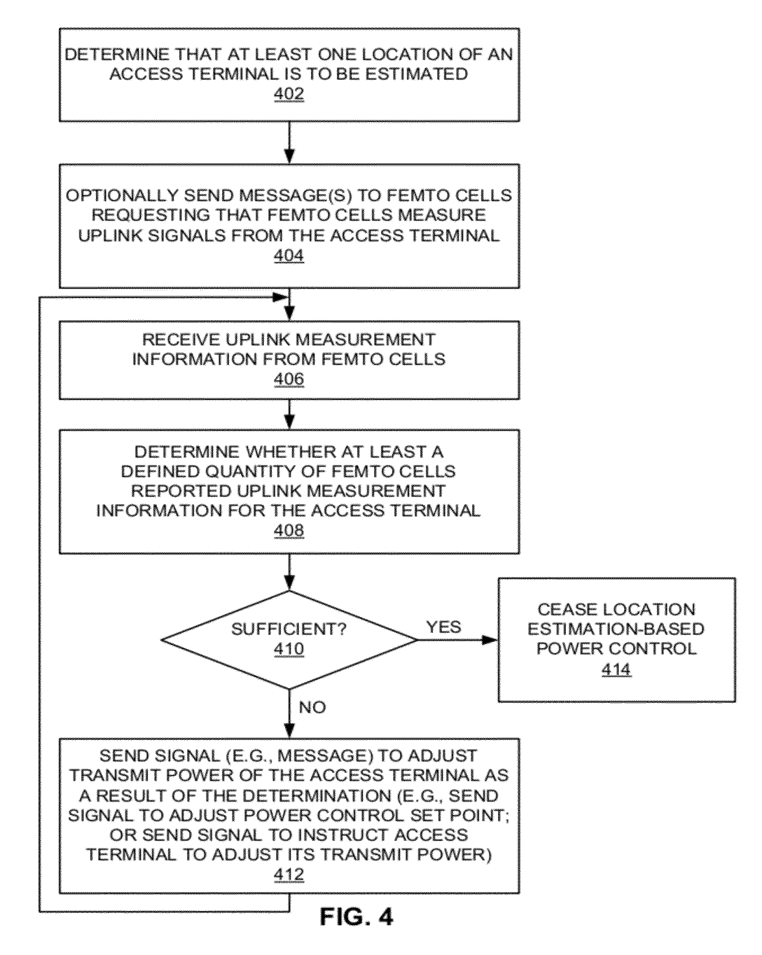

Access terminal transmit power control 124 involves adjusting the transmit power of the access terminal in an attempt to control the number of femto cells that are able to effectively measure uplink signals from the access terminal. Examples of these operations are described in more detail below in conjunction with FIG. 4.

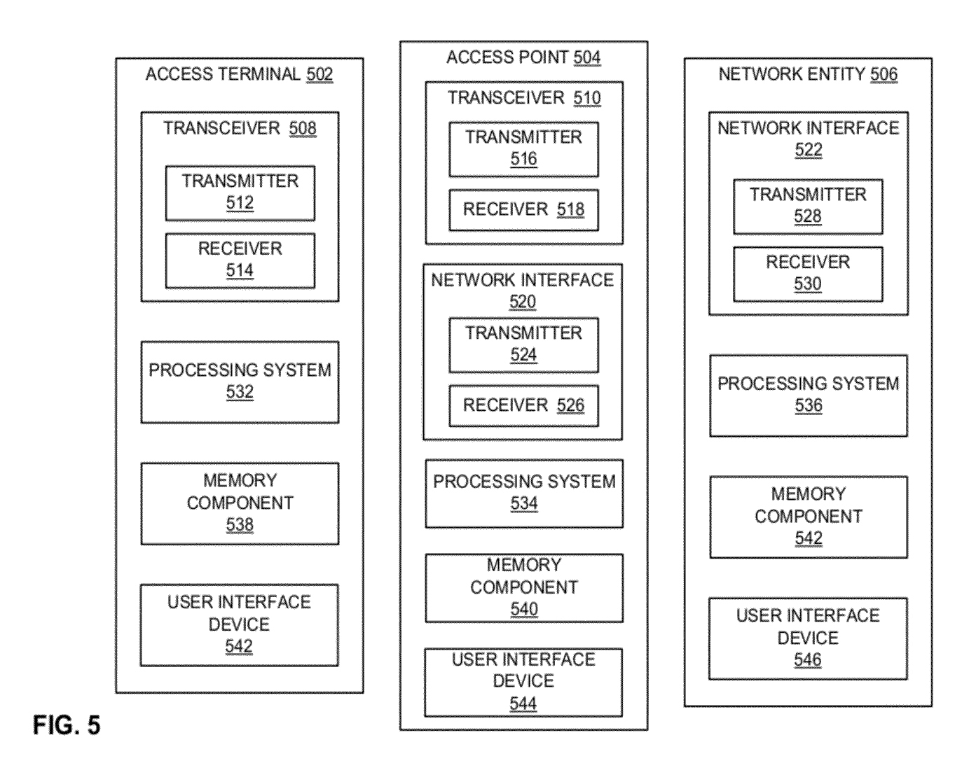

For convenience, the operations of the flowcharts of FIGS. 2-4 (or any other operations discussed or taught herein) may be described as being performed by specific components (e.g., the components of FIG. 1 or FIG. 5). It should be appreciated, however, that these operations may be performed by other types of components and may be performed using a different number of components. It also should be appreciated that one or more of the operations described herein may not be employed in a given implementation.

Referring initially to FIG. 2, in some embodiments, the location of an access terminal is estimated based on values indicative of relative path loss that are derived from the access terminal's uplink signals. For example, a group of femto cells may each measure the signal strength of the pilot signal transmitted by the access terminal. Since the transmit power of the access terminal is unknown and dynamic, the path loss between the access terminal and a given femto cell cannot be estimated from these measurements. However, the difference of the measured strength at two femto cells is equal to the path loss difference from the current location of the access terminal to these femto cells. Thus the difference in the path loss values can be used as a fingerprint to estimate the current location of the access terminal.

The use of relative values reduces the triangulation set size by one. For example, if four femto cells (e.g., A, B, C, and D) are visible, then the fingerprint has three values (e.g., corresponding to femto cell sets A-B, A-C, and A-D).

Briefly, a relative path loss-based location scheme may involve the operations that follow. When the location of an access terminal is to be estimated, a set of femto cells (e.g., all of the femto cells in the vicinity the serving femto cell for the access terminal) are instructed to make uplink measurements (e.g., of pilot signals) for the access terminal. In one aspect of the disclosed approach, the measurement is done on a particular long-code in the reference pilot. Further, in an implementation where pilot signals are measured for location estimation, the reference pilot signal may be shifted in timing for finer granularity estimation. The femto cells that are able to sense the access terminal send the measured Ecp/Nt (ratio of the access terminal's pilot strength to the sum of all other signals on the channel) and Nt values to the requesting entity (e.g., a location estimation server implemented in a network entity or the serving femto cell). The requesting entity uses this information to calculate a path loss difference for each femto cell pair and attempts to find a match to this set of differences in the database to predict the access terminal's location.

Various aspects of a sample embodiment of a relative path loss-based location estimation scheme will be described in some detail in conjunction with the discussion of the operational blocks of FIG. 2 that follows.

As represented by block 202, at some point in time, an entity in the network determines that at least one location of the access terminal is to be estimated. For example, a client in the access terminal, a serving femto cell, a network entity, or some other entity may trigger a location estimation procedure. Alternatively, location estimation may be invoked on a regular (e.g., periodic) basis. If the client is in the access terminal, the access terminal will generally have application layer protocols to communicate with a server to exchange information needed by or provided by the location estimation procedure (e.g., measurement information, map information, location estimate).

As represented by block 204, as a result of the determination of block 202, at least one message may be sent to a set of femto cells requesting that the femto cells measure uplink signals from the access terminal and/or requesting signal strength information from the femto cells. For example, the message may include an identifier (e.g., a long-code) associated with the access terminal, along with a request that the femto cells measure pilot signals from the access terminal and report the measured signal strength. As another example, in cases where the femto cells automatically conduct uplink measurements, the message may simply request that the femto cells report the measured signal strength for the specified access terminal (or, optionally, all measured access terminals).

The message(s) of block 204 may take various forms. For example, a single message that requests the actions above may be sent to all of the femto cells. As another example, a dedicated message may be sent to each femto cell, whereby that message only requests action on the part of that femto cell.

The operations of block 204 (as well as the other operations of FIG. 2) may be performed by various entities. In some embodiments, these operations are performed by a network entity (e.g., a femto management server, etc.). In some embodiments, these operations are performed by one of the femto cells (e.g., the serving femto cell for the access terminal). In this latter case, the femto cell sends the message(s) to the other femto cells via a network entity or some other suitable path. Also in this case, the femto cell will conduct its own measurements.

The uplink measurements are conducted when the access terminal is in an active call. If the access terminal is not active, a dummy call can be initiated.

As represented by block 206, signal strength information corresponding to signals measured by the femto cells is received from the femto cells. As discussed herein, in some implementations this information indicates the access terminal pilot strength as seen by each femto cell. Here, in implementations where the requesting entity is a network entity, the serving femto cell for the access terminal will send its measurement information to the network entity. In contrast, in implementations where the requesting entity is the serving femto cell, the serving femto cell will maintain its measurement information so that it may be used along with the information received from the other femto cells.

As represented by block 208, relative path loss values associated with the femto cells are determined based on the received signal strength information. In particular, indications of the differences in path loss between different pairs of femto cells may be calculated here. In some aspects, the number of differences in this set of differences (e.g., which may be referred to as relative path loss values herein) depends on the number of femto cells that reported signal strength information.

In some embodiments, the determination of the relative path loss values comprises determining differences between received signal strength values measured by different femto cells. In this case, the determined relative path loss values may comprise these determined differences. That is, the difference in the received signal strength of signals from a given access terminal as seen by two femto cells corresponds to (i.e., is indicative of) the difference between the path loss from one of the femto cells to the access terminal and the path loss from the other one of the femto cells to the access terminal. Hence, this difference may be referred to herein as a relative path loss value.

As represented by block 210, a location of the access terminal is estimated based on the relative path loss values. In some embodiments, this involves comparing the determined relative path loss values to sets of previously defined relative path loss values that are associated with different locations (e.g., the fingerprints stored in the database), and then identifying a location based on the comparison. For example, the determined relative path loss values may be compared with sets of previously defined relative path loss values stored in the database to identify (e.g., predict) one or more sets that substantially match the determined relative path loss values. The location of the access terminal may then be estimated based on the location(s) associated with the identified set(s). For example, the estimated location may be calculated as a mean of the locations associated with several identified sets.

As a specific example, a fingerprint corresponding to the determined relative path loss values is matched against a database that contains sets of relative path loss values, where each set of defined relative path loss values corresponds to a unique one of a plurality of defined locations (points) within the coverage region of the femto cells. Based on these values, the point with the maximum likelihood of having the determined fingerprint is predicted. For example, the determined relative path loss values may be represented by {PL_{f1-f2}, PL_{f1-f3}, PL_{f1-f4} . . . }. The set of points that maximize a likelihood function based on these relative path loss values may thus be determined and used to estimate a location of the access terminal.

Referring to FIG. 3, in some embodiments, the location of an access terminal is estimated based on signal propagation delay values that are derived from measurements of the access terminal's uplink signals conducted by a group of femto cells. Here, a serving femto cell may estimate the propagation delay from the access terminal by comparing the reverse link frame boundary from the access terminal with its own forward link frame boundary. Other femto cells may then perform a similar comparison. The estimated delay from the access terminal to each femto cell can then be computed using the comparison shifted by the timing difference between the serving femto cell and the other femto cell. In a synchronous system such as cdma2000 1x, the reference timing difference between each femto cell should be very small.

In one aspect of the disclosed approach, the propagation delay may consist of the round-trip delay time (RTT) between the access terminal and a given femto cell. In one approach, the femto cell may send a request to the access terminal, wait for a response, and then determine the true round trip time by subtracting the expected hold time at the access terminal (the time between the access terminal getting the request and responding) from the timing.

In implementations that employ timing-based triangulation, each estimated delay may then be used to estimate the distance from the access terminal to a given femto cell. The resulting location values may then be triangulated to estimate the location of the access terminal.

In implementations that employ fingerprint-based location estimation, a fingerprint (e.g., indicative of the propagation delays between the access terminal and the different femto cells) is obtained based on the delay estimates. This fingerprint is then matched against a database of similar values to estimate the current location of the access terminal.

The accuracy of a timing-based location estimation scheme depends, for example, on the number of femto cells to which time delay can be measured and the resolution at which the time can be reported. In some cases, the measurement resolution is typically at chip/16 granularity. The accuracy of the observed timing may be improved using the following technique. A femto cell gradually adjusts its reference pilot timing with increment of 1/x chip and observes when the estimated delay increases by 1/16 chip. If this happens after y increments, the true time delay is increased by approximately (1−y/x)/16 chips more than originally estimated.

Various aspects of a sample embodiment of a timing-based location estimation scheme will be described in some detail in conjunction with the discussion of the operational blocks of FIG. 3 that follows.

Block 302 of FIG. 3 corresponds to block 202 of FIG. 2. Thus, a determination is made that at least one location of the access terminal is to be estimated.

As represented by block 304, as a result of the determination of block 302, at least one message may be sent to a set of femto cells requesting that the femto cells measure uplink signals from the access terminal and/or requesting signal propagation delay values from the femto cells. For example, the message may include an identifier (e.g., a long-code) associated with the access terminal, along with a request that the femto cells measure pilot signals from the access terminal and report the signal propagation delay values. As another example, in cases where the femto cells automatically conduct uplink measurements, the message may simply request that the femto cells report the signal propagation delay values for the specified access terminal (or, optionally, all measured access terminals). In a similar manner as discussed above, the message(s) of block 304 may take various forms.

The operations of block 304 (as well as the other operations of FIG. 3) may be performed by various entities. For example, similar to FIG. 2 above, these operations may performed by a network entity, one of the femto cells, or some other entity.

As represented by block 306, signal propagation delay values corresponding to signals measured by the femto cells are received from the femto cells. In implementations where the requesting entity is a network entity, the femto cells in the vicinity of the access terminal will send its delay values to the network entity. In contrast, in implementations where the requesting entity is the serving femto cell, the serving femto cell will maintain its values so that they may be used along with the delay values the serving femto cell receives from the other femto cells.

As represented by block 308, the received signal propagation delay values are compared to sets of defined delay values that are associated with different locations. For example, the received signal propagation delay values may be compared with sets of previously defined signal propagation delay values stored in a database to identify (e.g., predict) one or more sets that substantially match the received signal propagation delay values.

As represented by block 310, a location of the access terminal is estimated based on the comparison of block 308. For example, the location of the access terminal may be estimated based on the location(s) associated with the identified set(s) described at block 308. In case where there are several identified sets, the estimated location may be calculated as a function (e.g., mean, median, etc.) of the locations associated with these sets.

As a specific example, a fingerprint corresponding to the received signal propagation delay values is matched against a database that contains sets of signal propagation delay values, where each set of defined signal propagation delay values corresponds to a unique one of a plurality of defined locations (points) within the coverage region of the femto cells. Based on these values, the point with the maximum likelihood of having the determined fingerprint is predicted. For example, the received signal propagation delay values may be represented by {D_{f1}, D_{f2}, D_{f3} . . . }. The set of points that maximize a likelihood function based on these signal propagation delay values is then determined and used to estimate a location of the access terminal.

Referring now to FIG. 4, the accuracy of uplink-based location estimation may be limited by the number of femto cells which can sense the access terminal. In general, for uplink signals (e.g., pilot signals) to be successfully decoded at a femto cell, the received SNR should be greater than a sensing threshold. If the access terminal transmit power is too low, the number of femto cells that can successfully decode the uplink signals may be small. Consequently, location estimation accuracy may suffer.

In accordance with the teachings herein, to increase the number of femto cells that may measure the uplink, a power control parameter (e.g., an Ecp/Nt target) for the access terminal may be increased at the femto cells in the active set for the access terminal, thereby causing the access terminal to temporarily increase its uplink transmit power. Thus, a different transmit power control parameter may be defined for an access terminal during a location estimation procedure than during normal mobility operations.

The increase in the power control parameter (e.g., target Ecp/Nt) also may increase interference in the uplink of macro cells in co-channel deployments. However, since the path loss from an access terminal to serving femto cell is generally very small compared to typical path loss to the macro cell, the increase in the target may be acceptable in typical deployments. Moreover, the power control parameter may be increased selectively on the access terminal that is being located.

Various aspects of a sample embodiment of an access terminal transmit power control scheme will be described in some detail in conjunction with the discussion of the operational blocks of FIG. 4 that follows.

As represented by block 402, at some point in time, it is determined that at least one location of an access terminal is to be estimated. As discussed above, this determination may be made by the access terminal, a serving femto cell, a network entity, or some other entity.

As represented by block 404, as a result of the determination of block 402, at least one message may be sent to a set of femto cells requesting that the femto cells measure uplink signals from the access terminal and/or requesting uplink measurement information from the femto cells. For example, the message may include an identifier (e.g., a long-code) associated with the access terminal, along with a request that the femto cells measure pilot signals from the access terminal and send an indication as to whether the access point is able to reliably decode uplink signals from the access terminal (e.g., the measured signal strength may be reported upon successful decoding).

The operations of block 404 (as well as the other operations of FIG. 4) may be performed by various entities. For example, similar to FIG. 2 above, these operations may performed by a network entity, one of the femto cells, or some other entity.

As represented by block 406, uplink measurement information based on the femto cells' attempts to measure the uplink signals is received from the femto cells. As represented by block 408, based on this information, a determination is made as to whether at least a defined quantity (e.g., 4) of the femto cells receive signals of sufficient quality from the access terminal.

As represented by blocks 410 and 412, if a sufficient number of femto cells do not receive signals of sufficient quality from the access terminal, a signal is sent to adjust the transmit power of the access terminal. Such a signal may comprise, for example: a signal such as a fast power control signal to increase/decrease transmit power; a message; or some other suitable information that may be used to adjust transmit power.

In some implementations, the signal specifies a change in a power control parameter that a femto cell uses to adjust the transmit power of the access terminal. For example, the signal may be sent to a femto cell (e.g., by a network entity) and instruct the femto cell to adjust (e.g., increase) a power control set point for the access terminal. Here, the femto cell may be any of the femto cells in the active set for the access terminal since these femto cells are allowed to control the transmit power of the access terminal. Thus, the signal may be sent to the serving femto cell for the access terminal or to any other femto cell in the active set.

In implementations where the operations of FIG. 4 are performed by a femto cell of the active set, the signal of block 412 may be sent to the access terminal and instruct the access terminal to increase transmit power. For example, as a result of the determination of block 408, the femto cell may adjust a power control set point for the access terminal. Then, upon receiving a signal from the access terminal, the serving femto cell compares the received signal with the adjusted power control set point (e.g., to determine whether the set point is reached). Based on the result of this comparison, the access terminal sends a signal (e.g., comprising an indication to “increase power”) to the access terminal.

As represented by the arrow from block 412 to block 406, signals may be repeatedly sent until at least a defined quantity of femto cells receive signals of sufficient quality from the access terminal. As represented by block 414, in the event a sufficient number of the femto cells receive signals of sufficient quality from the access terminal, the location estimation-based power control procedure may be terminated.

Also, once the location estimation procedure completes, a signal (or signals) may be sent to revert the access terminal transmit power back to its prior setting. For example, the power control parameter maintained at the serving femto cell may be restored to its previous value.

In general, the location estimation techniques describe above rely on obtaining a fingerprint of the access terminal and matching it against a database. It may be desirable to increase the number of entries in the fingerprint database as the more entries that exist, the better the triangulation. The variation of these entries in space also is a factor because path loss typically has a high gradient in indoor environments. The variability in these entries at the same point over time and measurement error is also important as the path loss at a point from a femto cell is not a single value but a distribution due to channel fading and multipath. Since the database may be fixed, for a fixed location in space, the predicted point will change with time. Errors in measurement will also cause these errors. To overcome some of these shortcomings and improve the system, one or more of the techniques that follow may be employed.

In some implementations, a combination of the above-described approaches for location measurement may be employed to combat fading.

To improve the accuracy of the distance estimation, the teachings herein may be combined with techniques that estimate distance based on downlink (DL) measurements (e.g., wherein an access terminal measures received signal strength or timing of signals received from femto cells) other radio technologies (e.g., Wi-Fi). In some DL implementations, a database of macro path loss is generated. In this case, CFS may be used to obtain macro path loss measurements that may be used as additional degrees in the fingerprint. It should be noted that mapping macro path loss may be difficult as it uses knowledge of macro cell locations and, in general, careful measurements all around the required area. The total interference on the macro or femto channels can also be used for the same purpose, although the gradient in these quantities may not be as strong as path loss.

In some implementations, architectural maps of the building and other higher level contextual information can be used to improve the system. The information can be used to develop probabilistic models of motion which can be used in particle filters. A Markov model may be developed to model the access terminal's movement as a finite state space. These methods may lead to high improvement as indoor motion in a given space is largely predictable based on the importance of different areas in a building and physical limitations of walls.

In some implementations, a beamforming beacon transmitter may be used to help extract more out of the each femto cell measurement. With an omnidirectional antenna, only path loss can be measured which in some sense locates the access terminal in a circle around the femto cell. In contrast, with a beamforming transmitter, the specific direction of the user can also be disambiguated and thus location estimation is better.

In some navigation-related implementations, the system may use information from past and current measurements, as well as past and current predicted positions of the user. Apart from this, the system will try to take advantage of the layout and floor plan of the building itself. It will use the floor plan and other meta information to predict the most likely next position of the user as it would know the set of possible points as limited by physical restraints (going through a wall) and by popularity of the place (learnt through crowd sourcing or from the plan itself). If the system is helping navigate the user from point A to B, it knows the path it has recommended and thus locating and guiding the user along the path will be much easier.

Through the use of the location estimation techniques taught herein, an access terminal user may advantageously be able to use a variety of location-based services even in an indoor environment. For example, a user may be able to locate himself/herself indoors on a map and navigate to desired areas. A user may be able to locate himself/herself and friends in public places, find the path to their point of interest, and receive information on services in their immediate vicinity. Enterprises that deploy femto cells may be able to track their resources and staff and efficiently manage their workforce.

FIG. 5 illustrates several sample components (represented by corresponding blocks) that may be incorporated into nodes such as an access terminal 502, an access point 504, and a network entity 506 (e.g., corresponding to the access terminal 102, the access point 104, and the network entity 112, respectively, of FIG. 1) to perform transmit power control-related operations as taught herein. The described components also may be incorporated into other nodes in a communication system. For example, other nodes in a system may include components similar to those described for one or more of the access terminal 502, the access point 504, or the network entity 506 to provide similar functionality. Also, a given node may contain one or more of the described components. For example, an access point may contain multiple transceiver components that enable the access point to operate on multiple carriers and/or communicate via different technologies.

As shown in FIG. 5, the access terminal 502 and the access point 504 each include one or more wireless transceivers (as represented by a transceiver 508 and a transceiver 510, respectively) for communicating with other nodes. Each transceiver 508 includes a transmitter 512 for sending signals (e.g., messages, measurement reports, indications, other types of information, and so on) and a receiver 514 for receiving signals (e.g., messages, FL signals, pilot signals, location estimation-related parameters, other types of information, and so on). Similarly, each transceiver 510 includes a transmitter 516 for sending signals (e.g., messages, requests, indications, FL signals, pilot signals, location estimation-related parameters, other types of information, and so on) and a receiver 518 for receiving signals (e.g., messages, measurement reports, other types of information, and so on).

The access point 504 and the network entity 506 each include one or more network interfaces (as represented by a network interface 520 and a network interface 522, respectively) for communicating with other nodes (e.g., other network entities). For example, the network interfaces 520 and 522 may be configured to communicate with one or more network entities via a wire-based or wireless backhaul or backbone. In some aspects, the network interfaces 520 and 522 may be implemented as a transceiver (e.g., including transmitter and receiver components) configured to support wire-based or wireless communication (e.g., sending and receiving: signals, messages, measurement reports, indications, location estimation-related parameters, signal strength information, delay values, other types of information, and so on). Accordingly, in the example of FIG. 5, the network interface 520 is shown as comprising a transmitter 524 for sending signals and a receiver 526 for receiving signals. Similarly, the network interface 522 is shown as comprising a transmitter 528 for sending signals and a receiver 530 for receiving signals.

The access terminal 502, the access point 504, and the network entity 506 also include other components that may be used to support power control-related operations as taught herein. For example, the access terminal 502 includes a processing system 532 for providing functionality relating to location estimation (e.g., determine that the location of the access terminal is to be estimated) and for providing other processing functionality. Similarly, the access point 504 includes a processing system 534 for providing functionality relating to location estimation (e.g., receive signal strength information, determine relative path loss values, estimate a location of an access terminal, determine that at least one location of an access terminal is to be estimated, send at least one message requesting signal strength information, send a signal to adjust transmit power of an access terminal, adjust a power control set point, receiving a signal from an access terminal, comparing a received signal with an adjusted power control set point, receive signal propagation delay values, compare received signal propagation delay values to sets of defined delay values, send a message requesting signal propagation delay values) and for providing other processing functionality. Also, the network entity 506 includes a processing system 536 for providing functionality relating to location estimation (e.g., as described above for the processing system 534) and for providing other processing functionality. The access terminal 502, the access point 504, and the network entity 506 include memory components 538, 540, and 542 (e.g., each including a memory device), respectively, for maintaining information (e.g., fingerprint values, measurement report information, thresholds, parameters, and so on). In addition, the access terminal 502, the access point 504, and the network entity 506 include user interface devices 542, 544, and 546, respectively, for providing indications (e.g., audible and/or visual indications) to a user and/or for receiving user input (e.g., upon user actuation of a sensing device such a keypad, a touch screen, a microphone, and so on).

For convenience the access terminal 502 and the access point 504 are shown in FIG. 5 as including components that may be used in the various examples described herein. In practice, the illustrated blocks may have different functionality in different implementations. For example, the processing systems 532, 534, and 536 will be configured to support different operations in implementations that employ different wireless communication technologies.

The components of FIG. 5 may be implemented in various ways. In some implementations the components of FIG. 5 may be implemented in one or more circuits such as, for example, one or more processors and/or one or more ASICs (which may include one or more processors). Here, each circuit (e.g., processor) may use and/or incorporate data memory for storing information or executable code used by the circuit to provide this functionality. For example, some of the functionality represented by block 508 and some or all of the functionality represented by blocks 532, 538, and 542 may be implemented by a processor or processors of an access terminal and data memory of the access terminal (e.g., by execution of appropriate code and/or by appropriate configuration of processor components). Similarly, some of the functionality represented by block 510 and some or all of the functionality represented by blocks 520, 534, 540, and 544 may be implemented by a processor or processors of an access point and data memory of the access point (e.g., by execution of appropriate code and/or by appropriate configuration of processor components). Also, some or all of the functionality represented by blocks 522, 536, 542, and 546 may be implemented by a processor or processors of a network entity and data memory of the network entity (e.g., by execution of appropriate code and/or by appropriate configuration of processor components).

As discussed above, in some aspects the teachings herein may be employed in a network that includes macro scale coverage (e.g., a large area cellular network such as a 3G network, typically referred to as a macro cell network or a WAN) and smaller scale coverage (e.g., a residence-based or building-based network environment, typically referred to as a LAN). As an access terminal (AT) moves through such a network, the access terminal may be served in certain locations by access points that provide macro coverage while the access terminal may be served at other locations by access points that provide smaller scale coverage. In some aspects, the smaller coverage nodes may be used to provide incremental capacity growth, in-building coverage, and different services (e.g., for a more robust user experience).

In the description herein, a node (e.g., an access point) that provides coverage over a relatively large area may be referred to as a macro access point while a node that provides coverage over a relatively small area (e.g., a residence) may be referred to as a femto access point. It should be appreciated that the teachings herein may be applicable to nodes associated with other types of coverage areas. For example, a pico access point may provide coverage (e.g., coverage within a commercial building) over an area that is smaller than a macro area and larger than a femto area. In various applications, other terminology may be used to reference a macro access point, a femto access point, or other access point-type nodes. For example, a macro access point may be configured or referred to as an access node, base station, access point, eNodeB, macro cell, and so on. Also, a femto access point may be configured or referred to as a Home NodeB, Home eNodeB, access point base station, femto cell, and so on. In some implementations, a node may be associated with (e.g., referred to as or divided into) one or more cells or sectors. A cell or sector associated with a macro access point, a femto access point, or a pico access point may be referred to as a macro cell, a femto cell, or a pico cell, respectively.

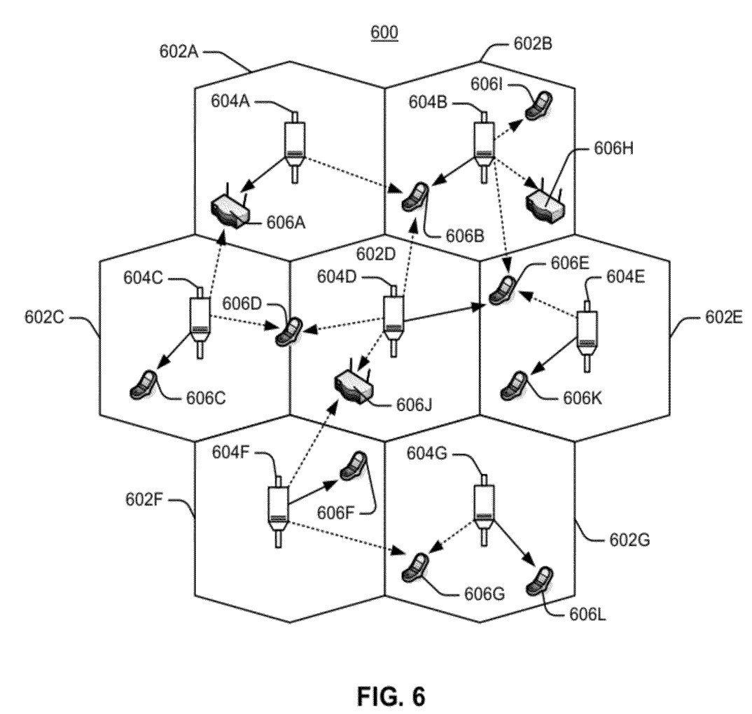

FIG. 6 illustrates a wireless communication system 600, configured to support a number of users, in which the teachings herein may be implemented. The system 600 provides communication for multiple cells 602, such as, for example, macro cells 602A-602G, with each cell being serviced by a corresponding access point 604 (e.g., access points 604A-604G). As shown in FIG. 6, access terminals 606 (e.g., access terminals 606A-606L) may be dispersed at various locations throughout the system over time. Each access terminal 606 may communicate with one or more access points 604 on a forward link (FL) and/or a reverse link (RL) at a given moment, depending upon whether the access terminal 606 is active and whether it is in soft handoff, for example. The wireless communication system 600 may provide service over a large geographic region. For example, macro cells 602A-602G may cover a few blocks in a neighborhood or several miles in a rural environment.

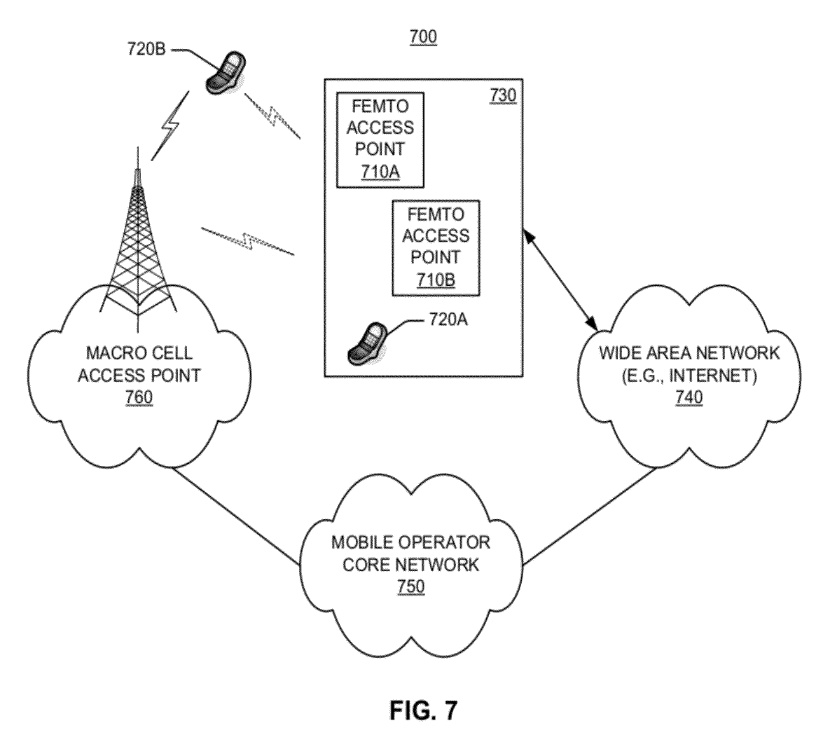

FIG. 7 illustrates an exemplary communication system 700 where one or more femto access points are deployed within a network environment. Specifically, the system 700 includes multiple femto access points 710 (e.g., femto access points 710A and 710B) installed in a relatively small scale network environment (e.g., in one or more user residences 730). Each femto access point 710 may be coupled to a wide area network 740 (e.g., the Internet) and a mobile operator core network 750 via a DSL router, a cable modem, a wireless link, or other connectivity means (not shown). As will be discussed below, each femto access point 710 may be configured to serve associated access terminals 720 (e.g., access terminal 720A) and, optionally, other (e.g., hybrid or alien) access terminals 720 (e.g., access terminal 720B). In other words, access to femto access points 710 may be restricted whereby a given access terminal 720 may be served by a set of designated (e.g., home) femto access point(s) 710 but may not be served by any non-designated femto access points 710 (e.g., a neighbor's femto access point 710).

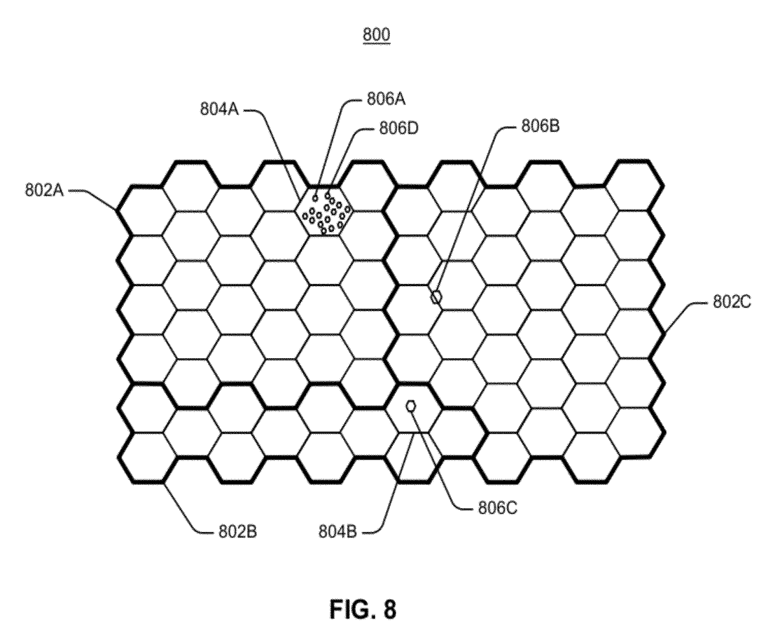

FIG. 8 illustrates an example of a coverage map 800 where several tracking areas 802 (or routing areas or location areas) are defined, each of which includes several macro coverage areas 804. Here, areas of coverage associated with tracking areas 802A, 802B, and 802C are delineated by the wide lines and the macro coverage areas 804 are represented by the larger hexagons. The tracking areas 802 also include femto coverage areas 806. In this example, each of the femto coverage areas 806 (e.g., femto coverage areas 806B and 806C) is depicted within one or more macro coverage areas 804 (e.g., macro coverage areas 804A and 804B). It should be appreciated, however, that some or all of a femto coverage area 806 may not lie within a macro coverage area 804. In practice, a large number of femto coverage areas 806 (e.g., femto coverage areas 806A and 806D) may be defined within a given tracking area 802 or macro coverage area 804. Also, one or more pico coverage areas (not shown) may be defined within a given tracking area 802 or macro coverage area 804.

Referring again to FIG. 7, the owner of a femto access point 710 may subscribe to mobile service, such as, for example, 3G mobile service, offered through the mobile operator core network 750. In addition, an access terminal 720 may be capable of operating both in macro environments and in smaller scale (e.g., residential) network environments. In other words, depending on the current location of the access terminal 720, the access terminal 720 may be served by a macro cell access point 760 associated with the mobile operator core network 750 or by any one of a set of femto access points 710 (e.g., the femto access points 710A and 710B that reside within a corresponding user residence 730). For example, when a subscriber is outside his home, he is served by a standard macro access point (e.g., access point 760) and when the subscriber is at home, he is served by a femto access point (e.g., access point 710A). Here, a femto access point 710 may be backward compatible with legacy access terminals 720.

A femto access point 710 may be deployed on a single frequency or, in the alternative, on multiple frequencies. Depending on the particular configuration, the single frequency or one or more of the multiple frequencies may overlap with one or more frequencies used by a macro access point (e.g., access point 760).

In some aspects, an access terminal 720 may be configured to connect to a preferred femto access point (e.g., the home femto access point of the access terminal 720) whenever such connectivity is possible. For example, whenever the access terminal 720A is within the user's residence 730, it may be desired that the access terminal 720A communicate only with the home femto access point 710A or 710B.

In some aspects, if the access terminal 720 operates within the macro cellular network 750 but is not residing on its most preferred network (e.g., as defined in a preferred roaming list), the access terminal 720 may continue to search for the most preferred network (e.g., the preferred femto access point 710) using a better system reselection (BSR) procedure, which may involve a periodic scanning of available systems to determine whether better systems are currently available and subsequently acquire such preferred systems. The access terminal 720 may limit the search for specific band and channel. For example, one or more femto channels may be defined whereby all femto access points (or all restricted femto access points) in a region operate on the femto channel(s). The search for the most preferred system may be repeated periodically. Upon discovery of a preferred femto access point 710, the access terminal 720 selects the femto access point 710 and registers on it for use when within its coverage area.

Access to a femto access point may be restricted in some aspects. For example, a given femto access point may only provide certain services to certain access terminals. In deployments with so-called restricted (or closed) access, a given access terminal may only be served by the macro cell mobile network and a defined set of femto access points (e.g., the femto access points 710 that reside within the corresponding user residence 730). In some implementations, an access point may be restricted to not provide, for at least one node (e.g., access terminal), at least one of: signaling, data access, registration, paging, or service.

In some aspects, a restricted femto access point (which may also be referred to as a Closed Subscriber Group Home NodeB) is one that provides service to a restricted provisioned set of access terminals. This set may be temporarily or permanently extended as necessary. In some aspects, a Closed Subscriber Group (CSG) may be defined as the set of access points (e.g., femto access points) that share a common access control list of access terminals.

Various relationships may thus exist between a given femto access point and a given access terminal. For example, from the perspective of an access terminal, an open femto access point may refer to a femto access point with unrestricted access (e.g., the femto access point allows access to any access terminal). A restricted femto access point may refer to a femto access point that is restricted in some manner (e.g., restricted for access and/or registration). A home femto access point may refer to a femto access point on which the access terminal is authorized to access and operate on (e.g., permanent access is provided for a defined set of one or more access terminals). A hybrid (or guest) femto access point may refer to a femto access point on which different access terminals are provided different levels of service (e.g., some access terminals may be allowed partial and/or temporary access while other access terminals may be allowed full access). An alien femto access point may refer to a femto access point on which the access terminal is not authorized to access or operate on, except for perhaps emergency situations (e.g., 911 calls).

From a restricted femto access point perspective, a home access terminal may refer to an access terminal that is authorized to access the restricted femto access point installed in the residence of that access terminal's owner (usually the home access terminal has permanent access to that femto access point). A guest access terminal may refer to an access terminal with temporary access to the restricted femto access point (e.g., limited based on deadline, time of use, bytes, connection count, or some other criterion or criteria). An alien access terminal may refer to an access terminal that does not have permission to access the restricted femto access point, except for perhaps emergency situations, for example, such as 911 calls (e.g., an access terminal that does not have the credentials or permission to register with the restricted femto access point).

For convenience, the disclosure herein describes various functionality in the context of a femto access point. It should be appreciated, however, that a pico access point may provide the same or similar functionality for a larger coverage area. For example, a pico access point may be restricted, a home pico access point may be defined for a given access terminal, and so on.

The teachings herein may be employed in a wireless multiple-access communication system that simultaneously supports communication for multiple wireless access terminals. Here, each terminal may communicate with one or more access points via transmissions on the forward and reverse links. The forward link (or downlink) refers to the communication link from the access points to the terminals, and the reverse link (or uplink) refers to the communication link from the terminals to the access points. This communication link may be established via a single-in-single-out system, a multiple-in-multiple-out (MIMO) system, or some other type of system.

A MIMO system employs multiple (N_{T}) transmit antennas and multiple (N_{R}) receive antennas for data transmission. A MIMO channel formed by the N_{T} transmit and N_{R} receive antennas may be decomposed into Nₛ independent channels, which are also referred to as spatial channels, where N_{S}<min{N_{T}, N_{R}}. Each of the N_{S} independent channels corresponds to a dimension. The MIMO system may provide improved performance (e.g., higher throughput and/or greater reliability) if the additional dimensionalities created by the multiple transmit and receive antennas are utilized.

A MIMO system may support time division duplex (TDD) and frequency division duplex (FDD). In a TDD system, the forward and reverse link transmissions are on the same frequency region so that the reciprocity principle allows the estimation of the forward link channel from the reverse link channel. This enables the access point to extract transmit beam-forming gain on the forward link when multiple antennas are available at the access point.

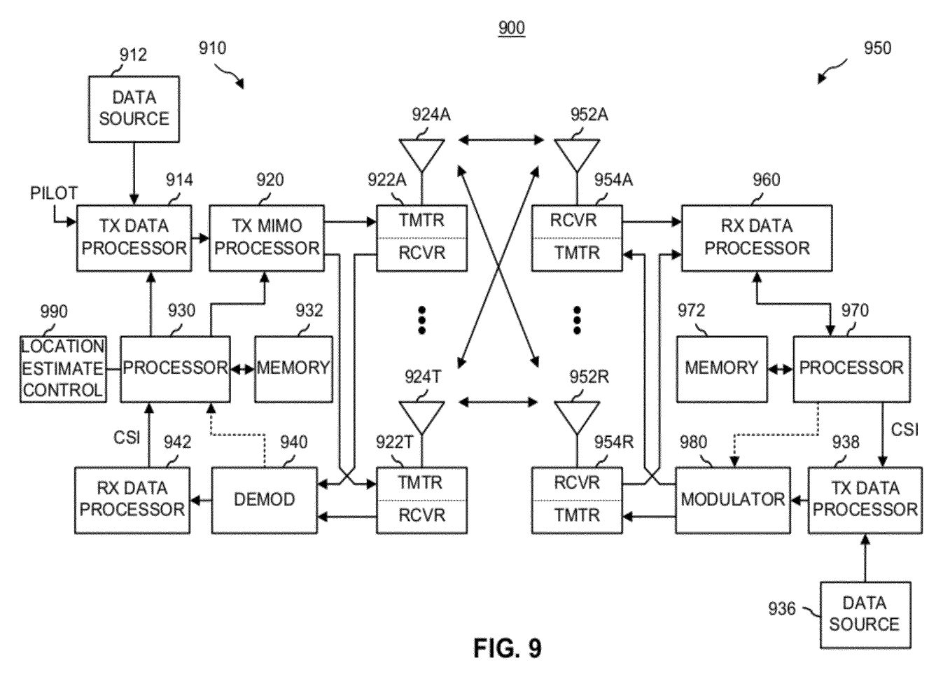

FIG. 9 illustrates a wireless device 910 (e.g., an access point) and a wireless device 950 (e.g., an access terminal) of a sample MIMO system 900. At the device 910, traffic data for a number of data streams is provided from a data source 912 to a transmit (TX) data processor 914. Each data stream may then be transmitted over a respective transmit antenna.

The TX data processor 914 formats, codes, and interleaves the traffic data for each data stream based on a particular coding scheme selected for that data stream to provide coded data. The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (i.e., symbol mapped) based on a particular modulation scheme (e.g., BPSK, QSPK, M-PSK, or M-QAM) selected for that data stream to provide modulation symbols. The data rate, coding, and modulation for each data stream may be determined by instructions performed by a processor 930. A data memory 932 may store program code, data, and other information used by the processor 930 or other components of the device 910.

The modulation symbols for all data streams are then provided to a TX MIMO processor 920, which may further process the modulation symbols (e.g., for OFDM). The TX MIMO processor 920 then provides N_{T} modulation symbol streams to N_{T} transceivers (XCVR) 922A through 922T. In some aspects, the TX MIMO processor 920 applies beam-forming weights to the symbols of the data streams and to the antenna from which the symbol is being transmitted.

Each transceiver 922 receives and processes a respective symbol stream to provide one or more analog signals, and further conditions (e.g., amplifies, filters, and upconverts) the analog signals to provide a modulated signal suitable for transmission over the MIMO channel. N_{T} modulated signals from transceivers 922A through 922T are then transmitted from N_{T} antennas 924A through 924T, respectively.

At the device 950, the transmitted modulated signals are received by N_{R} antennas 952A through 952R and the received signal from each antenna 952 is provided to a respective transceiver (XCVR) 954A through 954R. Each transceiver 954 conditions (e.g., filters, amplifies, and downconverts) a respective received signal, digitizes the conditioned signal to provide samples, and further processes the samples to provide a corresponding “received” symbol stream.

A receive (RX) data processor 960 then receives and processes the N_{R} received symbol streams from N_{R} transceivers 954 based on a particular receiver processing technique to provide N_{T} “detected” symbol streams. The RX data processor 960 then demodulates, deinterleaves, and decodes each detected symbol stream to recover the traffic data for the data stream. The processing by the RX data processor 960 is complementary to that performed by the TX MIMO processor 920 and the TX data processor 914 at the device 910.

A processor 970 periodically determines which pre-coding matrix to use (discussed below). The processor 970 formulates a reverse link message comprising a matrix index portion and a rank value portion. A data memory 972 may store program code, data, and other information used by the processor 970 or other components of the device 950.

The reverse link message may comprise various types of information regarding the communication link and/or the received data stream. The reverse link message is then processed by a TX data processor 938, which also receives traffic data for a number of data streams from a data source 936, modulated by a modulator 980, conditioned by the transceivers 954A through 954R, and transmitted back to the device 910.

At the device 910, the modulated signals from the device 950 are received by the antennas 924, conditioned by the transceivers 922, demodulated by a demodulator (DEMOD) 940, and processed by a RX data processor 942 to extract the reverse link message transmitted by the device 950. The processor 930 then determines which pre-coding matrix to use for determining the beam-forming weights then processes the extracted message.

FIG. 9 also illustrates that the communication components may include one or more components that perform location estimation control operations as taught herein. For example, a location estimate control component 990 may cooperate with the processor 930 and/or other components of the device 910 to estimate the location of another device (e.g., device 950) as taught herein. It should be appreciated that for each device 910 and 950 the functionality of two or more of the described components may be provided by a single component. For example, a single processing component may provide the functionality of the location estimate control component 990 and the processor 930.

The teachings herein may be incorporated into various types of communication systems and/or system components. In some aspects, the teachings herein may be employed in a multiple-access system capable of supporting communication with multiple users by sharing the available system resources (e.g., by specifying one or more of bandwidth, transmit power, coding, interleaving, and so on). For example, the teachings herein may be applied to any one or combinations of the following technologies: Code Division Multiple Access (CDMA) systems, Multiple-Carrier CDMA (MCCDMA), Wideband CDMA (W-CDMA), High-Speed Packet Access (HSPA, HSPA+) systems, Time Division Multiple Access (TDMA) systems, Frequency Division Multiple Access (FDMA) systems, Single-Carrier FDMA (SC-FDMA) systems, Orthogonal Frequency Division Multiple Access (OFDMA) systems, or other multiple access techniques. A wireless communication system employing the teachings herein may be designed to implement one or more standards, such as IS-95, cdma2000, IS-856, W-CDMA, TDSCDMA, and other standards. A CDMA network may implement a radio technology such as Universal Terrestrial Radio Access (UTRA), cdma2000, or some other technology. UTRA includes W-CDMA and Low Chip Rate (LCR). The cdma2000 technology covers IS-2000, IS-95 and IS-856 standards. A TDMA network may implement a radio technology such as Global System for Mobile Communications (GSM). An OFDMA network may implement a radio technology such as Evolved UTRA (E-UTRA), IEEE 802.11, IEEE 802.16, IEEE 802.20, Flash-OFDM®, etc. UTRA, E-UTRA, and GSM are part of Universal Mobile Telecommunication System (UMTS). The teachings herein may be implemented in a 3GPP Long Term Evolution (LTE) system, an Ultra-Mobile Broadband (UMB) system, and other types of systems. LTE is a release of UMTS that uses E-UTRA. UTRA, E-UTRA, GSM, UMTS and LTE are described in documents from an organization named “3rd Generation Partnership Project” (3GPP), while cdma2000 is described in documents from an organization named “3rd Generation Partnership Project 2” (3GPP2). Although certain aspects of the disclosure may be described using 3GPP terminology, it is to be understood that the teachings herein may be applied to 3GPP (e.g., Re199, Re15, Re16, Re17) technology, as well as 3GPP2 (e.g., 1xRTT, 1xEV-DO Rel0, RevA, RevB) technology and other technologies.

The teachings herein may be incorporated into (e.g., implemented within or performed by) a variety of apparatuses (e.g., nodes). In some aspects, a node (e.g., a wireless node) implemented in accordance with the teachings herein may comprise an access point or an access terminal.

For example, an access terminal may comprise, be implemented as, or known as user equipment, a subscriber station, a subscriber unit, a mobile station, a mobile, a mobile node, a remote station, a remote terminal, a user terminal, a user agent, a user device, or some other terminology. In some implementations an access terminal may comprise a cellular telephone, a cordless telephone, a session initiation protocol (SIP) phone, a wireless local loop (WLL) station, a personal digital assistant (PDA), a handheld device having wireless connection capability, or some other suitable processing device connected to a wireless modem. Accordingly, one or more aspects taught herein may be incorporated into a phone (e.g., a cellular phone or smart phone), a computer (e.g., a laptop), a portable communication device, a portable computing device (e.g., a personal data assistant), an entertainment device (e.g., a music device, a video device, or a satellite radio), a global positioning system device, or any other suitable device that is configured to communicate via a wireless medium.

An access point may comprise, be implemented as, or known as a NodeB, an eNodeB, a radio network controller (RNC), a base station (BS), a radio base station (RBS), a base station controller (BSC), a base transceiver station (BTS), a transceiver function (TF), a radio transceiver, a radio router, a basic service set (BSS), an extended service set (ESS), a macro cell, a macro node, a Home eNB (HeNB), a femto cell, a femto node, a pico node, or some other similar terminology.

In some aspects a node (e.g., an access point) may comprise an access node for a communication system. Such an access node may provide, for example, connectivity for or to a network (e.g., a wide area network such as the Internet or a cellular network) via a wired or wireless communication link to the network. Accordingly, an access node may enable another node (e.g., an access terminal) to access a network or some other functionality. In addition, it should be appreciated that one or both of the nodes may be portable or, in some cases, relatively non-portable.

Also, it should be appreciated that a wireless node may be capable of transmitting and/or receiving information in a non-wireless manner (e.g., via a wired connection). Thus, a receiver and a transmitter as discussed herein may include appropriate communication interface components (e.g., electrical or optical interface components) to communicate via a non-wireless medium.

A wireless node may communicate via one or more wireless communication links that are based on or otherwise support any suitable wireless communication technology. For example, in some aspects a wireless node may associate with a network. In some aspects the network may comprise a local area network or a wide area network. A wireless device may support or otherwise use one or more of a variety of wireless communication technologies, protocols, or standards such as those discussed herein (e.g., CDMA, TDMA, OFDM, OFDMA, WiMAX, Wi-Fi, and so on). Similarly, a wireless node may support or otherwise use one or more of a variety of corresponding modulation or multiplexing schemes. A wireless node may thus include appropriate components (e.g., air interfaces) to establish and communicate via one or more wireless communication links using the above or other wireless communication technologies. For example, a wireless node may comprise a wireless transceiver with associated transmitter and receiver components that may include various components (e.g., signal generators and signal processors) that facilitate communication over a wireless medium.

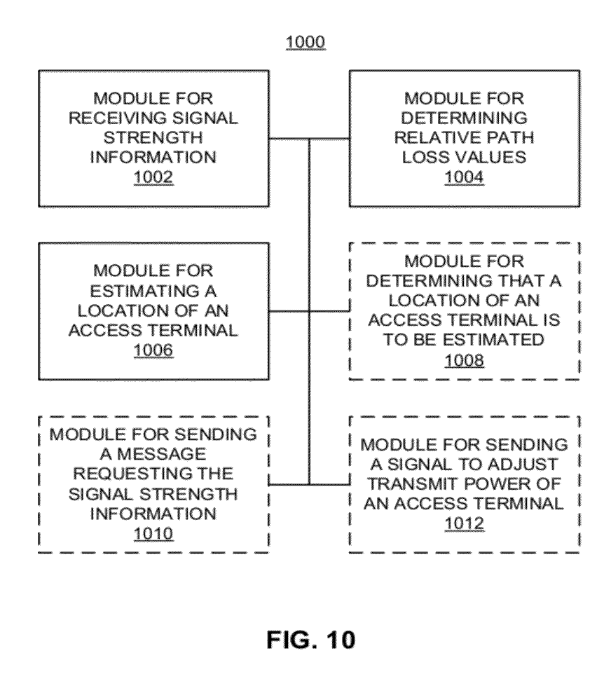

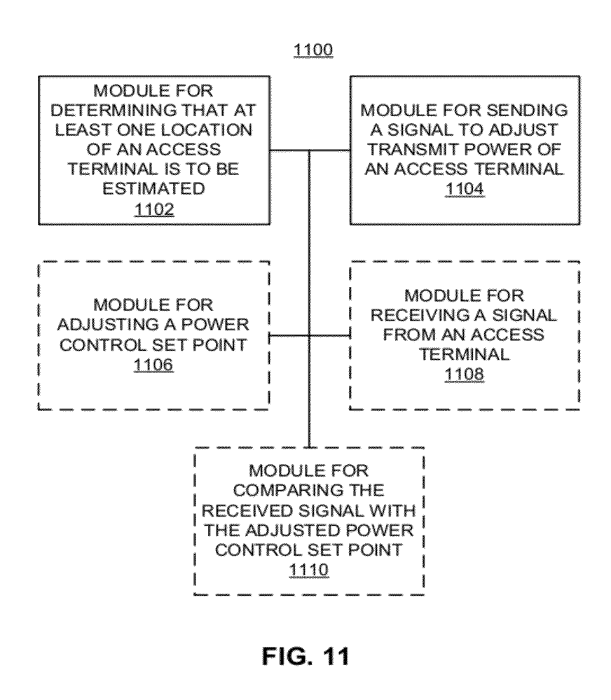

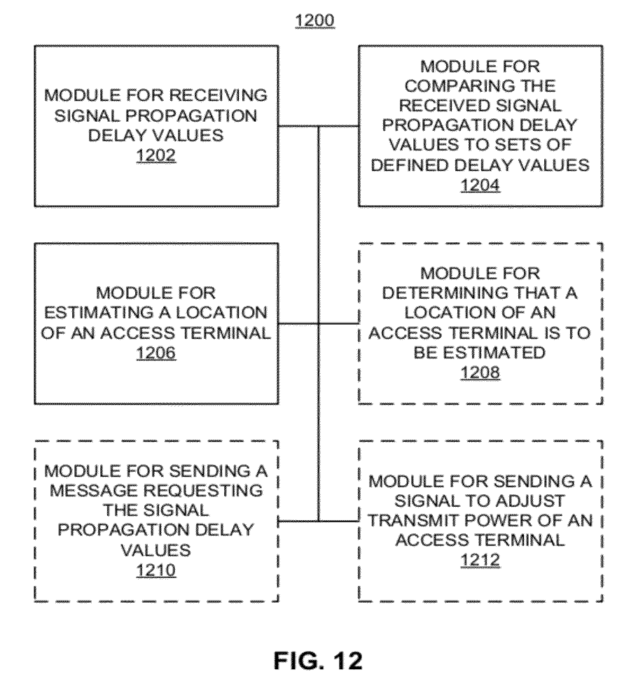

The functionality described herein (e.g., with regard to one or more of the accompanying figures) may correspond in some aspects to similarly designated “means for” functionality in the appended claims. Referring to FIGS. 10-12, apparatuses 1000, 1100, and 1200 are represented as a series of interrelated functional modules. Here, a module for receiving signal strength information 1002 may correspond at least in some aspects to, for example, a receiver as discussed herein. A module for determining relative path loss values 1004 may correspond at least in some aspects to, for example, a processing system as discussed herein. A module for estimating a location of an access terminal 1006 may correspond at least in some aspects to, for example, a processing system as discussed herein. A module for determining that a location of an access terminal is to be estimated 1008 may correspond at least in some aspects to, for example, a processing system as discussed herein. A module for sending a message requesting the signal strength information 1010 may correspond at least in some aspects to, for example, a transmitter as discussed herein. A module for ending a signal to control transmit power of an access terminal 1012 may correspond at least in some aspects to, for example, a transmitter as discussed herein. A module for determining that at least one location of an access terminal is to be estimated 1102 may correspond at least in some aspects to, for example, a processing system as discussed herein. A module for sending a message to control transmit power of an access terminal 1104 may correspond at least in some aspects to, for example, a transmitter as discussed herein. A module for adjusting a power control set point 1106 may correspond at least in some aspects to, for example, a processing system as discussed herein. A module for receiving a signal from an access terminal 1108 may correspond at least in some aspects to, for example, a receiver as discussed herein. A module for comparing the received signal with the adjusted power control set point 1110 may correspond at least in some aspects to, for example, a processing system as discussed herein. A module for receiving signal propagation delay values 1202 may correspond at least in some aspects to, for example, a receiver as discussed herein. A module for comparing the received signal propagation delay values to sets of defined delay values 1204 may correspond at least in some aspects to, for example, a processing system as discussed herein. A module for estimating a location of an access terminal 1206 may correspond at least in some aspects to, for example, a processing system as discussed herein. A module for determining that a location of an access terminal is to be estimated 1208 may correspond at least in some aspects to, for example, a processing system as discussed herein. A module for sending a message requesting the signal propagation delay values 1210 may correspond at least in some aspects to, for example, a transmitter as discussed herein. A module for sending a signal to adjust transmit power of an access terminal 1212 may correspond at least in some aspects to, for example, a transmitter as discussed herein.

The functionality of the modules of FIGS. 10-12 may be implemented in various ways consistent with the teachings herein. In some aspects the functionality of these modules may be implemented as one or more electrical components. In some aspects the functionality of these blocks may be implemented as a processing system including one or more processor components. In some aspects the functionality of these modules may be implemented using, for example, at least a portion of one or more integrated circuits (e.g., an ASIC). As discussed herein, an integrated circuit may include a processor, software, other related components, or some combination thereof. The functionality of these modules also may be implemented in some other manner as taught herein. In some aspects one or more of any dashed blocks in FIGS. 10-12 are optional.

In some embodiments, an apparatus for communication implemented in accordance with the teachings herein comprises: a receiver configured to receive, from a plurality of femto cells, signal propagation delay values corresponding to signals received by the femto cells from an access terminal; and a processing system configured to compare the received signal propagation delay values to sets of defined delay values that are associated with different locations, and further configured to estimate a location of the access terminal based on the comparison. In some embodiments, the comparison comprises identifying at least one of the sets of the defined delay values that substantially matches the received signal propagation delay values. In some embodiments, the estimation of the location is based on locations associated with the identified at least one set of defined delay values. In some embodiments, the processing system is further configured to determine that the location of the access terminal is to be estimated; and the apparatus further comprises a transmitter configured to send at least one message requesting the signal propagation delay values from the femto cells, wherein the message is sent as a result of the determination that the location of the access terminal is to be estimated. In some embodiments, the apparatus further comprises a transmitter configured to send a signal to control transmit power of the access terminal to facilitate the reception of the signals by the femto cells. In some embodiments, a message is sent as a result of a determination that the location of the access terminal is to be estimated. In some embodiments, a message is sent as a result of a determination as to whether at least a defined quantity of the femto cells receive signals of sufficient quality from the access terminal. In some embodiments, a method implemented in accordance with the teachings herein comprises one or more operations corresponding to one or more of the above aspects. In some embodiments, a computer-program product implemented in accordance with the teachings herein comprises codes configured to cause a computer to provide functionality corresponding to one or more of the above aspects.

It should be understood that any reference to an element herein using a designation such as “first,” “second,” and so forth does not generally limit the quantity or order of those elements. Rather, these designations may be used herein as a convenient method of distinguishing between two or more elements or instances of an element. Thus, a reference to first and second elements does not mean that only two elements may be employed there or that the first element must precede the second element in some manner. Also, unless stated otherwise a set of elements may comprise one or more elements. In addition, terminology of the form “at least one of A, B, or C” or “one or more of A, B, or C” or “at least one of the group consisting of A, B, and C” used in the description or the claims means “A or B or C or any combination of these elements.”

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that any of the various illustrative logical blocks, modules, processors, means, circuits, and algorithm steps described in connection with the aspects disclosed herein may be implemented as electronic hardware (e.g., a digital implementation, an analog implementation, or a combination of the two, which may be designed using source coding or some other technique), various forms of program or design code incorporating instructions (which may be referred to herein, for convenience, as “software” or a “software module”), or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented within or performed by an integrated circuit (IC), an access terminal, or an access point. The IC may comprise a general purpose processor, a digital signal processor (DSP), an application specific integrated circuit (ASIC), a field programmable gate array (FPGA) or other programmable logic device, discrete gate or transistor logic, discrete hardware components, electrical components, optical components, mechanical components, or any combination thereof designed to perform the functions described herein, and may execute codes or instructions that reside within the IC, outside of the IC, or both. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

It is understood that any specific order or hierarchy of steps in any disclosed process is an example of a sample approach. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Thus, in some aspects computer readable medium may comprise non-transitory computer readable medium (e.g., tangible media). In addition, in some aspects computer readable medium may comprise transitory computer readable medium (e.g., a signal). Combinations of the above should also be included within the scope of computer-readable media. It should be appreciated that a computer-readable medium may be implemented in any suitable computer-program product.

As used herein, the term “determining” encompasses a wide variety of actions. For example, “determining” may include calculating, computing, processing, deriving, investigating, looking up (e.g., looking up in a table, a database or another data structure), ascertaining, and the like. Also, “determining” may include receiving (e.g., receiving information), accessing (e.g., accessing data in a memory), and the like. Also, “determining” may include resolving, selecting, choosing, establishing, and the like.

The previous description of the disclosed aspects is provided to enable any person skilled in the art to make or use the present disclosure. Various modifications to these aspects will be readily apparent to those skilled in the art, and the generic principles defined herein may be applied to other aspects without departing from the scope of the disclosure. Thus, the present disclosure is not intended to be limited to the aspects shown herein but is to be accorded the widest scope consistent with the principles and novel features disclosed herein.

What is claimed is:

1. An apparatus for communication, comprising:
a receiver configured to receive, from a plurality of femto cells, signal strength information corresponding to signals measured by the femto cells from an access terminal; and
a processing system configured to determine relative path loss values associated with the femto cells based on the received signal strength information, and further configured to estimate a location of the access terminal based on the relative path loss values.

2. The apparatus of claim 1, wherein:
the determination of the relative path loss values comprises determining differences between received signal strength values measured by different ones of the femto cells; and
the determined relative path loss values comprise the determined differences.

3. The apparatus of claim 2, wherein the estimation of the location of the access terminal comprises:
comparing the determined relative path loss values to sets of defined relative path loss values that are associated with different locations; and
identifying a location based on the comparison.

4. The apparatus of claim 1, wherein the estimation of the location of the access terminal comprises:
comparing the determined relative path loss values to sets of defined relative path loss values that are associated with different locations; and
identifying a location based on the comparison.

5. The apparatus of claim 1, wherein:
the processing system is further configured to determine that the location of the access terminal is to be estimated;
the apparatus further comprises a transmitter configured to send at least one message requesting the signal strength information from the femto cells; and
the message is sent as a result of the determination that the location of the access terminal is to be estimated.

6. The apparatus of claim 1, wherein the apparatus further comprises a transmitter configured to send a signal to control transmit power of the access terminal to facilitate the measurement of the signals by the femto cells.

7. The apparatus of claim 6, wherein the signal is sent as a result of a determination that the location of the access terminal is to be estimated.

8. The apparatus of claim 6, wherein the signal is sent as a result of a determination as to whether at least a defined quantity of the femto cells receive signals of sufficient quality from the access terminal.

9. A method of communication, comprising:
receiving, from a plurality of femto cells, signal strength information corresponding to signals measured by the femto cells from an access terminal;
determining relative path loss values associated with the femto cells based on the received signal strength information; and
estimating a location of the access terminal based on the relative path loss values.

10. The method of claim 9, wherein:
the determination of the relative path loss values comprises determining differences between received signal strength values measured by different ones of the femto cells; and
the determined relative path loss values comprise the determined differences.

11. The method of claim 9, further comprising:
determining that the location of the access terminal is to be estimated; and
sending at least one message requesting the signal strength information from the femto cells, wherein the message is sent as a result of the determination that the location of the access terminal is to be estimated.

12. The method of claim 9, further comprising sending a signal to control transmit power of the access terminal to facilitate the measurement of the signals by the femto cells.

13. An apparatus for communication, comprising:
means for receiving, from a plurality of femto cells, signal strength information corresponding to signals measured by the femto cells from an access terminal;
means for determining relative path loss values associated with the femto cells based on the received signal strength information; and
means for estimating a location of the access terminal based on the relative path loss values.

14. The apparatus of claim 13, wherein:
the determination of the relative path loss values comprises determining differences between received signal strength values measured by different ones of the femto cells; and
the determined relative path loss values comprise the determined differences.

15. The apparatus of claim 13, further comprising:
means for determining that the location of the access terminal is to be estimated; and
means for sending at least one message requesting the signal strength information from the femto cells, wherein the message is sent as a result of the determination that the location of the access terminal is to be estimated.

16. The apparatus of claim 13, further comprising means for sending a signal to control transmit power of the access terminal to facilitate the measurement of the signals by the femto cells.

17. A computer-program product, comprising:
computer-readable medium comprising code for causing a computer to:
receive, from a plurality of femto cells, signal strength information corresponding to signals measured by the femto cells from an access terminal;
determine relative path loss values associated with the femto cells based on the received signal strength information; and
estimate a location of the access terminal based on the relative path loss values.

18. The computer-program product of claim 17, wherein:
the determination of the relative path loss values comprises determining differences between received signal strength values measured by different ones of the femto cells; and
the determined relative path loss values comprise the determined differences.

19. The computer-program product of claim 17, wherein:
the computer-readable medium further comprises code for causing the computer to determine that the location of the access terminal is to be estimated;
the computer-readable medium further comprises code for causing the computer to send at least one message requesting the signal strength information from the femto cells; and
the message is sent as a result of the determination that the location of the access terminal is to be estimated.

20. The computer-program product of claim 17, wherein the computer-readable medium further comprises code for causing the computer to send a signal to control transmit power of the access terminal to facilitate the measurement of the signals by the femto cells.

21. An apparatus for communication, comprising:
a processing system configured to determine that at least one location of an access terminal is to be estimated; and
a transmitter configured to send a signal to adjust transmit power of the access terminal as a result of the determination.

22. The apparatus of claim 21, wherein the signal specifies a change in a power control parameter that a femto cell in the active set for the access terminal uses to adjust the transmit power of the access terminal.

23. The apparatus of claim 21, wherein the signal instructs a serving femto cell for the access terminal to change a power control set point for the access terminal.

24. The apparatus of claim 21, wherein:
the processing system is further configured to adjust a power control set point for the access terminal as a result of the determination;
the apparatus further comprises a receiver configured to receive a signal from the access terminal;
the processing system is further configured to compare the received signal with the adjusted power control set point;
the signal is sent as a result of the comparison; and
the signal instructs the access terminal to increase transmit power.

25. The apparatus of claim 21, wherein the signal is sent as a result of a determination as to whether at least a defined quantity of the femto cells receive signals of sufficient quality from the access terminal.

26. The apparatus of claim 25, wherein the defined quantity is 4.

27. The apparatus of claim 21, wherein signals to adjust transmit power of the access terminal are repeatedly sent until at least a defined quantity of femto cells receive signals of sufficient quality from the access terminal.

28. A method of communication, comprising:
determining that at least one location of an access terminal is to be estimated; and
sending a signal to adjust transmit power of the access terminal as a result of the determination.

29. The method of claim 28, wherein the signal instructs a serving femto cell for the access terminal to change a power control set point for the access terminal.

30. The method of claim 28, further comprising:
adjusting a power control set point for the access terminal as a result of the determination;
receiving a signal from the access terminal; and
comparing the received signal with the adjusted power control set point, wherein:
the signal is sent as a result of the comparison, and
the signal instructs the access terminal to increase transmit power.

31. The method of claim 28, wherein the signal is sent as a result of a determination as to whether at least a defined quantity of the femto cells receive signals of sufficient quality from the access terminal.

32. An apparatus for communication, comprising:
means for determining that at least one location of an access terminal is to be estimated; and
means for sending a signal to adjust transmit power of the access terminal as a result of the determination.

33. The apparatus of claim 32, wherein the signal instructs a serving femto cell for the access terminal to change a power control set point for the access terminal.

34. The apparatus of claim 32, further comprising:
means for adjusting a power control set point for the access terminal as a result of the determination;
means for receiving a signal from the access terminal; and
means for comparing the received signal with the adjusted power control set point, wherein:
the signal is sent as a result of the comparison, and
the signal instructs the access terminal to increase transmit power.

35. The apparatus of claim 32, wherein the signal is sent as a result of a determination as to whether at least a defined quantity of the femto cells receive signals of sufficient quality from the access terminal.

36. A computer-program product, comprising:
computer-readable medium comprising code for causing a computer to:
determine that at least one location of an access terminal is to be estimated; and
send a signal to adjust transmit power of the access terminal as a result of the determination.

37. The computer-program product of claim 36, wherein the signal instructs a serving femto cell for the access terminal to change a power control set point for the access terminal.

38. The computer-program product of claim 36, wherein:
the computer-readable medium further comprises code for causing the computer to adjust a power control set point for the access terminal as a result of the determination;
the computer-readable medium further comprises code for causing the computer to receive a signal from the access terminal;
the computer-readable medium further comprises code for causing the computer to compare the received signal with the adjusted power control set point;
the signal is sent as a result of the comparison; and
the signal instructs the access terminal to increase transmit power.

39. The computer-program product of claim 36, wherein the signal is sent as a result of a determination as to whether at least a defined quantity of the femto cells receive signals of sufficient quality from the access terminal.
